(19) United States
(12) Patent Application Publication
(10) Pub. No.: US 2003/0088395 A1
(43) Pub. Date: May 8, 2003

(54) Method and system for quantifying dynamic on-chip power disribution

(76) Inventors: Roland Frech, Ostfildern (DE); Andreas Huber, Holzgerlingen (DE); Bernd Kemmler, Stuttgart (DE); Erich Klink, Schoenaich (DE)

Correspondence Address: Floyd A. Gonzalez, IBM Corporation, 2455 South Road, P386, Poughkeepsie, NY, 12601, US

(21) Appl. No.: 10/143,049

(22) Filed: May 10, 2002

(30) Foreign Application Priority Data
Nov. 5, 2001 (EP) 01111542.5

(51) Int. Cl. G06F 17/50

(52) U.S. Cl. 703/18

(57) ABSTRACT

The invention relates to a method and system for analyzing the dynamic behavior of an electrical circuit including a multiple layered power distribution system formed by a power grid and a plurality of electrical elements, said multiple layered power distribution system having at least two wiring layers providing a specified supply voltage level (U₀) to each of said electrical elements, said analysis resulting in a representation that allows a judgment of whether or not the voltage level at any of said electrical elements might leave a predetermined voltage range under the condition that a predetermined number of said electrical elements are driven at the same time span. A first representation of said multiple layered power distribution system is converted into a second representation being formed by an abstraction of the first representation by reducing the complexity of the multiple layered power distribution system by at least one wiring layer, and the dynamic behavior of said electrical circuit based on said second representation of said multiple layered power distribution system is analyzed. Advantageously, the method and system according to the present invention can be used for on-chip power supply network evaluation. It is even so efficient to be already used early in the chip development process.

### BACKGROUND OF THE INVENTION

The present invention generally relates to the field of design automation and computer-aided design (CAD) in the area of development of integrated circuits. Particularly, the present invention relates to a method and system for analyzing the dynamic behavior of an electrical circuit to determine whether a voltage level provided by a power distribution system might leave a predetermined voltage range under the condition that a predetermined number of electrical elements are switched in the same time span, i.e., the voltage level drops below or surmounts predefined voltage levels.

CMOS (Complementary Metal Oxide Semiconductor) circuit technology of today and its application in highly synchronously switching digital VLSI (Very Large Scale Integration) systems imposes high frequency current changes on the associated power supply network formed by a power supply wiring. The reason lies in the semiconductor fabrication technology. CMOS circuit technology uses a combination of n- and p-doped semiconductor material to achieve low power dissipation. Any path through a gate through which current can flow includes both n- and p-type transistors. Only one type is turned on in any stable state so there is low static power dissipation. However, a higher current flows when a gate switches in order to charge a parasitic capacitance.

The imposed current changes, in return, generate noise voltages, i.e., unintentional variation of the voltage level. Because of such variations, the supply voltage level might even leave a predetermined voltage range necessary for a faultless operation of the supplied circuits, which jeopardizes the operativeness of the whole system. Therefore one of the major challenges in modern circuit design is to design a reliable power distribution system, i.e., a power distribution system that provides a voltage supply the level of which stays within a predefined range of variation also under worst case conditions. Thus, the power supply is requested to have a minimum of noise voltage also if all gates in the circuit switch at one instant of time.

The general engineering approach is to build up a power supply network which keeps its impedance in each branch from DC (Direct Current) up to the highest needed frequencies, as low as possible. In such a system power supply, noise is at minimum. In order to achieve this, the designer designs a suitable power wiring structure and places decoupling capacitors for providing a local capacitance along the power path from the primary power source down to the switching circuits. The closer the switching circuit high frequency capacitors, i.e. ones with a good high frequency response, are placed the better the provision for high speed current changes. Ultimately, the power supply decoupling capacitors have to be distributed on chip level itself among the switching circuits. However, tools to simulate the on-chip power distribution are not commonplace today and very complex. Furthermore, it is hardly possible to use them interactively during chip physical design, because of their complexity.

### SUMMARY OF THE INVENTION

The object of the present invention is to provide a more efficient method and system for analyzing the dynamic behavior of an electrical circuit to determine whether a voltage level provided by a power distribution system might leave a predetermined voltage range during operation of the electrical circuit.

According to the present invention a method and a system is provided for analyzing the dynamic behavior of an electrical circuit, whereby the electrical circuit may be formed by an integrated circuit.

The electrical circuit includes a plurality of electrical elements and a power distribution system. The power distribution system is formed by a power wiring and a plurality of electrical elements. Furthermore, it comprises at least two wiring layers that provide a specified supply voltage level (U₀) to each of said electrical elements. Therefore it contains VDD and GND wires. The power wiring is fed by an external current or voltage source.

The analysis results in a representation judging whether or not the voltage level at any of said electrical elements might leave a predetermined voltage range under the condition that a predetermined number of said electrical elements are driven in the same period of time. In order to calculate a worst case scenario, it may be considered that all electrical elements are switched in the very same moment, i.e., all CMOS-gates switch from one state into another. However, in order to be as close to a real life scenario as possible, a probability of a switching activity for each gate may advantageously be taken into account. Non synchronous switching can also be taken into account.

In a preliminary step, a design data set representing technical details of the electrical circuit or the integrated circuit is read in order to extract the location and the value of the switching and non-switching capacitance Cₛ, C₀. Furthermore, wiring geometries and material information that impacts the wiring/propagation properties are provided, such as line width, height, spacing, conductivity, losses, dielectric constant etc. In addition, the switching probability, also called activity, of the electrical elements powered by the multiple layered power distribution system may be read in order to more accurately determine their power demand. In case exact switching activity is given, the real values can be used, otherwise the switching activity may be estimated.

Then, a first representation of said multiple layered power distribution system given by the initially provided information is converted into a second representation being formed by an abstraction of the first representation by reducing the complexity of the multiple layered power distribution system by at least one wiring layer. Preferably, the first representation is converted into an equivalent pair of parallel planes, whereby the electrical properties of the power distribution system are mapped into the parameters of a planar equivalent circuit, i.e., the plane pair. The non-switching capacitance C₀ may be either included in the model parameter or externally connected to this model.

Afterwards, the dynamic behavior of said electrical circuit based on said second representation of said multiple layered power distribution system is analyzed. Thus, the voltage level variation DU is calculated for each segment of the power distribution system or each electrical element. Finally, the calculated voltage level variation DU is displayed in relation to the respective segment or electrical element.

The method and device according to the present invention advantageously take into consideration power wiring inductance (resistance, capacitance and conductance may also be included) and on-chip propagation effects, both ensuring a higher accuracy of the analysis. Furthermore, the analysis can be executed in a length of time which is a magnitude shorter than known from prior art.

Advantageously, the method and system according to the present invention can be used for on-chip power supply network evaluation. Its efficiency lends itself to be used early in the chip development process. Thus, it may preferrably be used in the chip's physical design phase. Since the method and system measures the power supply integrity, i.e., whether the power supply operativeness is unimpaired by the circuit's operation, it optimizes the on-chip power distribution system, placement of circuits and electrical elements, chip layout and power supply decoupling capacitors quantitatively.

The method and device according to the present invention can also be applied to analyze chips having more than one VDDs and VDD domains, respectively. In this case the calculation of whether or not the voltage level at any of said electrical elements might leave a predetermined voltage range may be separately performed for each VDD.

The present invention can be realized in hardware, software, or a combination of hardware and software. Any kind of computer system—or other apparatus adapted for carrying out the methods described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

### BRIEF DESCRIPTION OF THE DRAWINGS

These and other objects will be apparent to one skilled in the art from the following detailed description of the invention taken in conjunction with the accompanying drawings in which:

FIG. 1 shows an electrical circuit diagram illustrating an effective local power supply capacitance C₀ and an equivalent local capacitance Cₛ;

FIG. 2 shows a perspective view of a regular three layer power grid in a multiple layered power distribution system to be analyzed in accordance with the present invention;

FIG. 3 shows a perspective view of a converted representation of the power distribution system as used in accordance with the present invention;

FIG. 4 shows a perspective view of a lumped equivalent of a single segment as used in the conversion process according to the present invention;

FIG. 5 shows a flow chart illustrating a method for analyzing the dynamic behavior of an electrical circuit to determine whether a voltage level provided by a power distribution system might leave a predetermined voltage range during operation of the electrical circuit according to the present invention;

FIG. 6 shows a view of a three-dimensional illustration representing the circuit area indicating a calculated maximum voltage level variation (DU) in accordance with the values determined for each portion of said circuit area according to the present invention;

FIG. 7 shows a chart depicting a horizontal scan of the three-dimensional illustration of FIG. 6; and

FIG. 8 shows a two-dimensional illustration representing the distribution of switching capacitance on a chip.

### DESCRIPTION OF THE PREFERRED EMBODIMENT

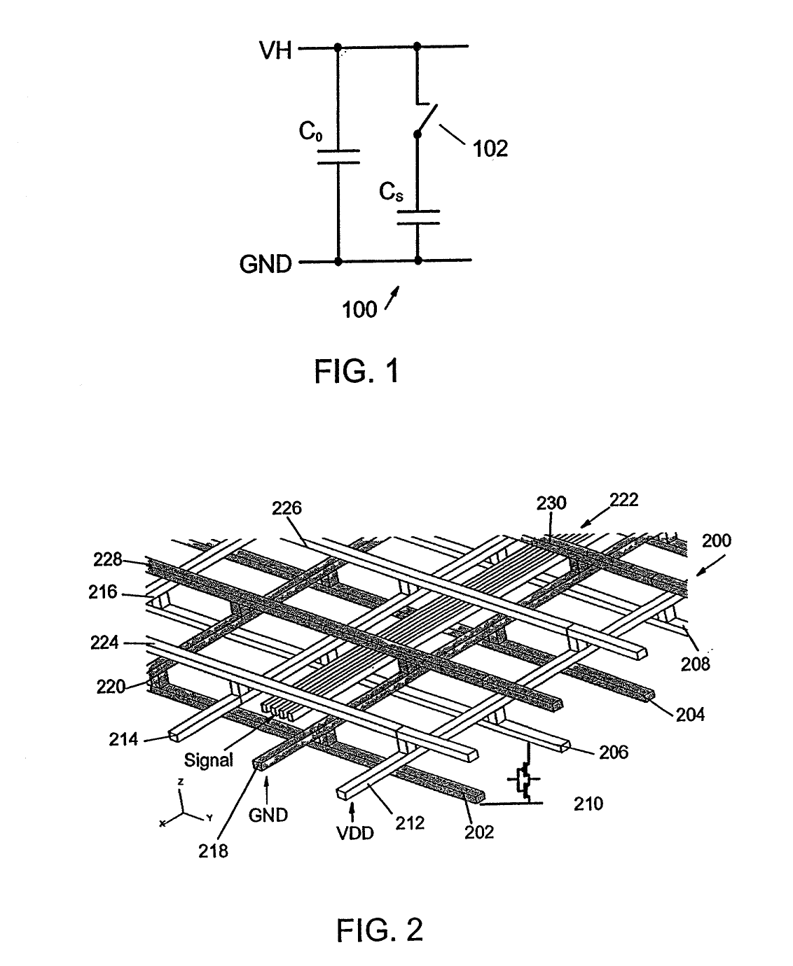

With reference to FIG. 1, there is depicted an electrical circuit diagram 100 illustrating the effective local power supply non-switching capacitance C₀ and an equivalent local switching capacitance Cₛ. Every single electrical element being part of the analyzed electrical circuit provides a certain capacitance. For the analysis according to the present invention the provided capacitance of each electrical element is divided in two different kinds. The first kind is a so called switching capacitance Cₛ, i.e., a capacitance which has to be charged whenever the respective electrical element changes it state or switches. The second kind, in contrast, is a non-switching capacitance C₀ which is not affected by the changing of the state of the electrical element nor by its switching. The non-switching capacitance C₀, however, keeps some electrical charge which might be supplied into the power supply network.

Charging a switching capacitance Cₛ of an electrical element during a switching event is the major physical effect which needs external power supply support. Due to the high switching speed, the inductance domination of the power supply path mainly dominates the behavior of the voltage level provided by the power supply network to the switching electrical elements. Because of this, an external power supply cannot instantly provide sufficient electrical charge demanded by an electrical element in order to charge the switching capacitance C_{S}. Instead, the electrical charge needed to charge the switching capacitance C_{S} is at first taken from a non-switching capacitance C₀ being situated very closely in relation to the switching location. Hence, only a fraction of the entire non-switching capacitance C₀ is available to provide the electrical charge that is needed in the moment of an switching event. Hence, an initial voltage collapse or voltage level variation DU of the nominal power supply voltage level U₀ might occur.

All physical structures, such as gates, transistors, electrical lines or even capacitors, can be illustrated by using an equivalent circuit diagram, in which, for a specific operation range, the physical structures are represented by a set of base components. From such a representation, the values for the non-switching capacitance C₀ and the switching capacitance Cₛ can be extracted. The non-switching capacitance C₀ behaves like an ordinary capacitor being directly connected between a ground line GND and a supply voltage line VH.

The switching capacitance Cₛ behaves like a capacitor being connected in series with a switch 102 between the ground line GND and the supply voltage line VH, as illustrated in FIG. 1. From the actual chip content placement, the distribution of C₀ and Cₛ for a worst case scenario can be extracted. However, as aforementioned, not only worst case scenarios may be calculated.

Now with reference to FIG. 2, there is depicted a perspective view of a regular three layer power grid 200 in a multiple layered power distribution system to be analyzed in accordance with the present invention. In a lower layer, a first and a second ground line are running in the y-direction in parallel to a first and a second supply voltage line 206 and 208. In order to illustrate that the ground and supply voltage lines serve to provide electrical circuits with energy, a gate 210 consisting of two CMOS transistors are exemplary drawn between the first ground line 202 and the first supply voltage line 206.

All lines of a middle layer are running orthogonal in view of the lines of the lower layer, i.e., in x-direction. In the middle layer there are drawn a third, a fourth and a fifth supply voltage line 212, 214, 216 respectively, a third and a fourth ground line 218 and 220 respectively, and four signal lines 222 situated between the third ground line 218 and the fourth supply voltage lines 214. In an upper layer a sixth and a seventh supply voltage line 224 and 226 are running in parallel to a fifth and sixth ground line 228 and 230.

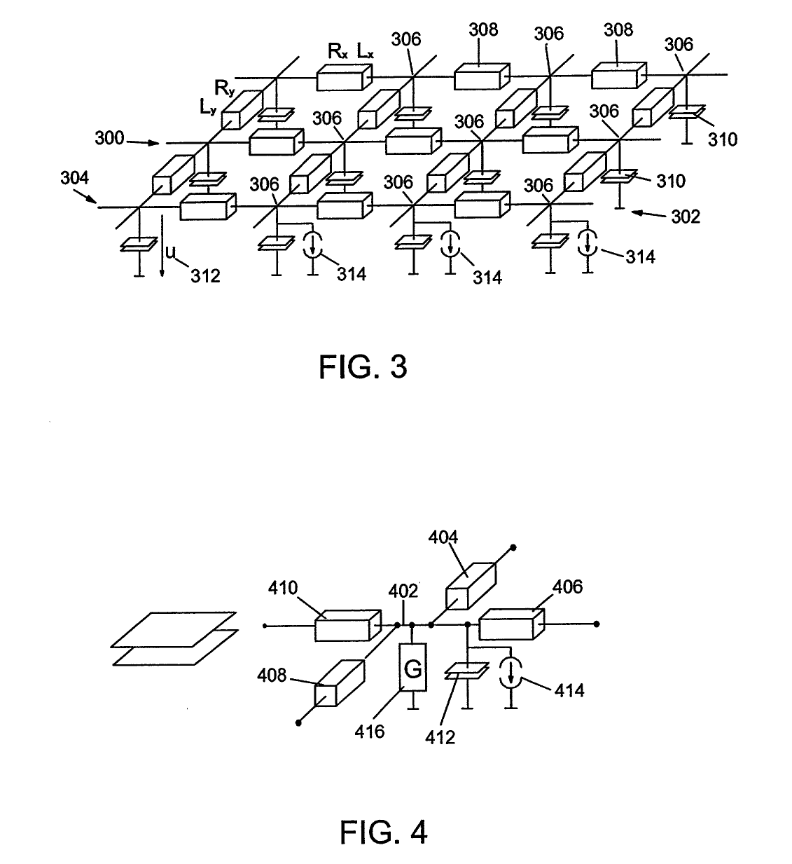

As it can be seen in FIG. 2, different ground lines as well as different supply voltage lines are connected to each other forming a multiple layered coplanar wiring structure. It is acknowledged that the presented power grid is only an example and other structures, either regular or irregular, might be the starting point for the method and device in accordance to the present invention. The complicated structure is analyzed and converted in a new representation having a reduced complexity. In a preferred embodiment, the power distribution system, such as the one shown in FIG. 2, is reduced to an equivalent pair of parallel planes as shown in FIG. 3.

In FIG. 3, there is shown a perspective view of a converted representation 300 of the power distribution system as used in accordance with the present invention. The converted representation 300 is formed by a single plane pair having a lower plane 302 as ground and a structure of interconnected electrical elements representing the behavior of the power distribution system forming a upper layer 304. The upper layer includes a plurality of connection points 306. At these connection points 306 four resistance/conductance elements (R-L-elements) 308 in the upper layer and at least a capacitance element 310 join together. The capacitance element 310 has the other terminal connected to the lower (ground) layer 302. The other terminals of the R-L-elements 308 of the upper layer are itself connected to other connection points 306 which are arranged in a grid like structure. In the front left corner, a voltage source 312 illustrates a connection of the power distribution system to the supply voltage. Several current sources 314 illustrate the switching activity of the simulated power distribution system. It is acknowledged that the present invention is not restricted to a reduction to a single plain pair as shown in FIG. 3. Moreover, any number of planes not larger than the number of the layers of the real power distribution system may be taken.

Now with reference to FIG. 4, there is depicted a perspective view of a lumped equivalent of a single segment as used in the conversion process according to the present invention. Each portion or segment of the real power distribution system gets converted into such a lumped equivalent. In an upper layer there is one connection point 402. At the connection point 402, four resistance/conductance elements (R-L-elements) 404, 406, 408 and 410 respectively, are positioned in the upper layer. From the connection point 402 a capacitance element 412, a conductivity element 414 and a current source 414 run to the ground layer. All the different R-L-elements 404 to 410 are combined with there neighboring elements when combining all single segments to the model as shown in FIG. 3. Alternatively, a distributed parameter system may be used instead of a representation with R-L-elements, i.e., the R-L-elements may be replaced by transmission line segments.

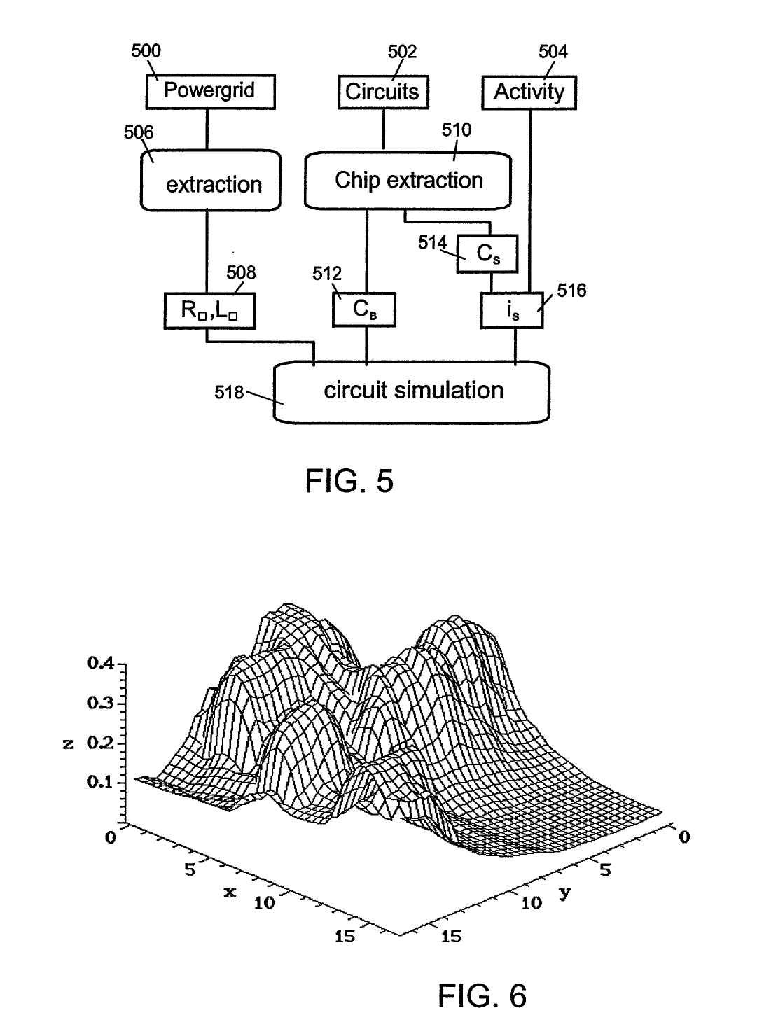

With reference now to FIG. 5, there is depicted a flow chart illustrating a method for analyzing the dynamic behavior of an electrical circuit to determine whether a voltage level provided by a power distribution system might leave a predetermined voltage range during operation of the electrical circuit according to the present invention. As an input, the information about power grid, the circuits and the activity in form of a description is needed, as illustrated by blocks 500, 502 and 504.

The power grid description contains the wiring geometries and material information that impacts the wiring/propagation properties, such as the line width, height, spacing, conductivity, losses, dielectric constant etc. The circuit description contains the circuit parameters that impact the power noise. Typically this includes the placement and routing, switching and non-switching capacitance. Instead of final routing, an routing estimate is possible. Since in real life scenarios, not all gates switch at every clock cycle, from the activity information, i.e., the probability of a gate switching in one clock cycle, is taken into consideration. However, if the exact switching activity is not known, an estimate might be taken instead.

From the power grid description, characteristic parameters of the equivalent planes are derived as depicted by block 506. This may be performed by means of extraction tools. As a result of the extraction, characteristic parameters of parallel planes R., L., C″ and G″ are derived. This is done by dividing the parallel planes of the power distribution system into segments, such as multiple square portions.

Then, as a preparation for the numerical simulation of the power grid, the created segments are represented by lumped elements as illustrated by block 508 and as shown in FIG. 4. The segments may be of any shape, preferably of square or rectangular shape. In a preferred embodiment of the present invention, the extracting tool is based on electromagnetic field solvers. However, basically any tool or methodology able to extract lumped element equivalents is suitable to be used. For example, any 3D extraction for the cells may be used. In case of homogenous wiring structures, also 2D extraction is eligible.

Block 510 represents the extraction of information from the circuit description. From the circuit description, the distribution of non-switching circuit capacitance C₀ is available. Inside a cell all non-switching capacitance C₀ and the power wiring capacitance C_{W} is collected into one lumped capacitance value C_{B}=C₀+C_{W}, as illustrated by block 512. Usually but not necessarily the wiring capacitance can be neglected, i.e., C_{W}<<C₀, compared to the non-switching circuit capacitance, i.e., C_{B}≅C₀. On the other hand, switching circuit capacitance Cₛ are extracted from the circuit information as illustrated by block 514. The influence of the switching circuit capacitance Cₛ on the behavior of the power distribution system is considered by taking the activity information into account as depicted by block 516.

In the derived representation of the power distribution system the circuit switching and activity may be modeled by equivalent switching current distribution iₛ.

From all such information derived from a first representation of the power distribution system formed by the power grid, the circuit information, and the activity information, a converted and simplified representation is built that can be simulated. The converted representation may looks like an 2D transmission line model as shown in FIG. 3. Alternatively the conductance G may also be added to this model. Furthermore, R and L elements of adjacent cells can be merged.

Finally, as illustrated by block 518, the voltage change DU is calculated and then displayed in relation to the respective segment of the power distribution system. Furthermore, displaying the calculated maximum voltage level variation DU includes the step of creating a two or three-dimensional illustration representing the circuit area indicating the calculated voltage level variation DU in accordance with the values determined for each portion. Thereby, two or three-dimensional illustration is preferably divided in the same way as the circuit or chip area. Displaying the noise voltage by animation of time varying noise voltage may also be possible.

The collapse matrix depends on how the functional units are built up, where they are placed on the chip and how the functional switching event is distributed. Because of the efficient processing scheme the calculation of the power collapse matrix can be done during chip content placement and, thus, guide to a power noise optimized and balanced design.

If the analysis exhibits too high collapse values, either additional power supply decoupling capacitors can be placed into the critical areas or the switching density has to be reduced by spreading out the affected circuits into a larger area, or power wiring could be changed. This analysis feedback loop provides a method to reduce on-chip voltage noise.

With reference now to FIG. 6, there is depicted a view of a three-dimensional illustration representing the circuit area indicating a calculated maximum voltage level variation DU in accordance with the values determined for each portion of said circuit area according to the present invention. Particularly, the example shows a graphical picture of a calculated power collapse matrix, calculated according to the methodology of this invention. However, for the sake of clarity, the grid is not so finely drawn as the actual measurements have been. Furthermore, only certain ranges of the calculated voltage level variation DU are marked by different pattern. It is acknowledged that an actual representation contains more details and the view of the three-dimensional representation of the results is preferably depicted by using different colors which represent specific ranges of voltage level variation, e.g., the portion of the illustration having a calculated voltage level variation in the range from 0.3 to 0.325 volts could be colored green.

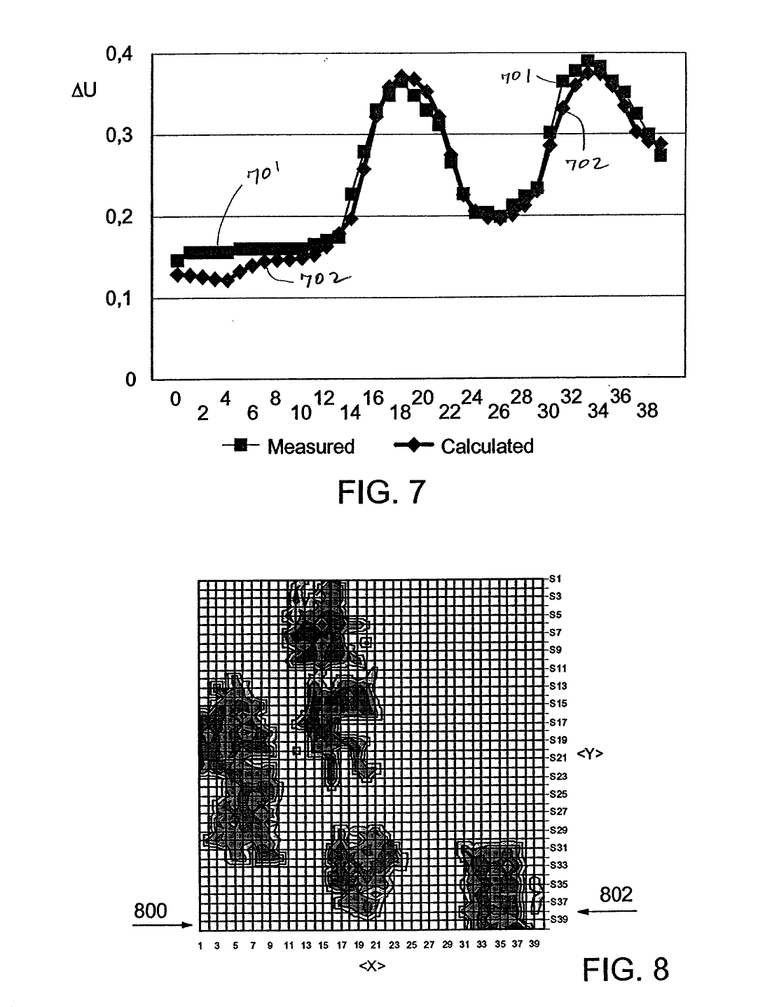

FIG. 7 shows a chart depicting a horizontal scan of the three-dimensional illustration of FIG. 6. Actually measured on-chip power voltage collapse values 701 and calculated values 702. Minor deviations are noticeable for chip areas without any switching activity. The collapse there is propagated from areas with switching activity. However, the most critical areas having a significant voltage level variation are calculated with a minimum of variation from the actually measured values.

Finally with reference to FIG. 8, there is depicted a two-dimensional illustration representing the distribution of switching capacitance Cₛ on a chip, whereby the line between arrows 800 and 802 mark the axis, along which the power noise shown in FIG. 7 was simulated and measured. However, for the sake of clarity the grid is not so finely drawn as the actual measurements have been. Furthermore, only certain ranges of the actual values of the switching capacitance Cₛ are marked by different pattern. It is acknowledged that an actual representation contains more details and the two-dimensional representation.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A method for analyzing the dynamic behavior of an electrical circuit including a multiple layered power distribution system formed by a power grid and a plurality of electrical elements, said multiple layered power distribution system having at least two wiring layers providing a specified supply voltage level (U₀) to each of said electrical elements, said analysis resulting in a representation that allows a judgment of whether or not the voltage level at any of said electrical elements might leave a predetermined voltage range under the condition that a predetermined number of said electrical elements are driven at the same time span, the method comprising the steps of:
converting a first representation of said multiple layered power distribution system into a second representation being formed by an abstraction of the first representation by reducing the complexity of the multiple layered power distribution system by at least one wiring layer, and
analyzing the dynamic behavior of said electrical circuit based on said second representation of said multiple layered power distribution system.

2. The method according to claim 1, wherein the step of converting a first representation of said multiple layered power distribution system into a second representation includes the step of extracting from a description of said electrical elements an indicator of their power demand.

3. The method according to claim 2, wherein the step of extracting from a description of said electrical elements an indicator of their power demand include the step of extracting from the circuit description of said electrical circuit the distribution of switching and non-switching capacitance.

4. The method according to claim 3, wherein the step of extracting from a description of said electrical elements an indicator of their power demand include the step of weighting the values of the switching capacitance by their switching probability.

5. The method according to claim 1, wherein the step of converting a first representation of said multiple layered power distribution system into a second representation includes the step of deriving from a geometrical description of the power distribution system, propagation parameters.

6. The method according to claim 5, wherein the step of deriving from a geometrical description of the power distribution system propagation parameters includes the usage of field solvers.

7. The method according to claim 1, wherein the step of converting a first representation of said multiple layered power distribution system into a second representation includes the step of dividing said first representation into segments.

8. The method according to claim 7, wherein the step of converting a first representation of said multiple layered power distribution system into a second representation includes the step of describing the behavior of the electrical elements situated in each segment by lumped parameters.

9. The method according to claim 8, wherein the step of converting a first representation of said multiple layered power distribution system into a second representation includes the step of neglecting the wiring capacitance of said multiple layered power distribution system.

10. The method according to claim 1, wherein the step of analyzing the dynamic behavior of said electrical circuit based on said second representation of said multiple layered power distribution system is performed by means of a circuit simulator tool.

11. The method according to claim 1, further comprising the step of displaying the calculated voltage level variation (DU) in relation to a respective segment of said multiple layered power distribution system.

12. The method according to claim 11, wherein the step of displaying the calculated voltage level variation (DU) includes the step of creating a three-dimensional illustration representing the circuit area indicating the calculated voltage level variation (DU) in accordance with the values determined for each segment.

13. The method according to claim 12, wherein the step of creating a three-dimensional illustration includes the step of dividing the three-dimensional illustration in the same way as the circuit area.

14. A system for analyzing the dynamic behavior of an electrical circuit including a multiple layered power distribution system formed by a power grid and a plurality of electrical elements, said multiple layered power distribution system having at least two wiring layers providing a specified supply voltage level (U₀) to each of said electrical elements, said analysis resulting in a representation that allows a judgment of whether or not the voltage level at any of said electrical elements might leave a predetermined voltage range under the condition that a predetermined number of said electrical elements are driven at the same time span, the system comprising:
a converter converting a first representation of said multiple layered power distribution system into a second representation being formed by an abstraction of the first representation by reducing the complexity of the multiple layered power distribution system by at least one wiring layer, and
an analyzer analyzing the dynamic behavior of said electrical circuit based on said second representation of said multiple layered power distribution system.

15. The system according to claim 14, wherein said converter includes an extractor extracting from a description of said electrical elements, an indicator of their power demand.

16. The system according to claim 15, wherein said extractor extracts from the circuit description of said electrical circuit, the distribution of switching and non-switching capacitance.

17. The system according to claim 16, wherein said extractor weights the values of the switching capacitance by their switching probability.

18. The system according to claim 14, wherein said converter derives from a geometrical description of the power distribution system, propagation parameters.

19. The system according to claim 18, wherein said converter includes the usage of field solvers for deriving from said geometrical description of the power distribution, said system propagation parameters.

20. The system according to claim 19, wherein said convertor divides said first representation into segments.

21. The system according to claim 20, wherein said convertor describes the behavior of the electrical elements situated in each segment by lumped parameters.

22. The system according to claim 21, wherein said convertor neglects the wiring capacitance of said multiple layered power distribution system when describing the behavior of the electrical elements.

23. The system according to claim 14, wherein said analyzer includes a circuit simulator tool for analyzing the dynamic behavior of said electrical circuit based on said second representation of said multiple layered power distribution system.

24. The system according to claim 14, further comprising a display for displaying the calculated voltage level variation (DU) in relation to a respective segment of said multiple layered power distribution system.

25. The system according to claim 24, wherein said display includes a three-dimensional illustration representing the circuit area indicating the calculated voltage level variation (DU) in accordance with the values determined for each segment.

26. The system according to claim 25, wherein said three-dimensional illustration is divided in the same way as the circuit area.

27. A program product for analyzing the dynamic behavior of an electrical circuit including a multiple layered power distribution system formed by a power grid and a plurality of electrical elements, said multiple layered power distribution system having at least two wiring layers providing a specified supply voltage level (U₀) to each of said electrical elements, said analysis resulting in a representation that allows a judgment of whether or not the voltage level at any of said electrical elements might leave a predetermined voltage range under the condition that a predetermined number of said electrical elements are driven at the same time span, the program product comprising:
a computer readable medium having recorded thereon computer readable program code performing the method comprising:
converting a first representation of said multiple layered power distribution system into a second representation being formed by an abstraction of the first representation by reducing the complexity of the multiple layered power distribution system by at least one wiring layer, and
analyzing the dynamic behavior of said electrical circuit based on said second representation of said multiple layered power distribution system.

28. The program product according to claim 27, wherein the method step of converting a first representation of said multiple layered power distribution system into a second representation includes the step of extracting from a description of said electrical elements an indicator of their power demand.

29. The program product according to claim 28, wherein the method step of extracting from a description of said electrical elements an indicator of their power demand include the step of extracting from the circuit description of said electrical circuit the distribution of switching and non-switching capacitance.

30. The program product according to claim 29, wherein the method step of extracting from a description of said electrical elements an indicator of their power demand include the step of weighting the values of the switching capacitance by their switching probability.

31. The program product according to claim 27, wherein the method step of converting a first representation of said multiple layered power distribution system into a second representation includes the step of deriving from a geometrical description of the power distribution system, propagation parameters.

32. The program product according to claim 31, wherein the method step of deriving from a geometrical description of the power distribution system propagation parameters includes the usage of field solvers.

33. The program product according to claim 27, wherein the method step of converting a first representation of said multiple layered power distribution system into a second representation includes the step of dividing said first representation into segments.

34. The program product according to claim 33, wherein the method step of converting a first representation of said multiple layered power distribution system into a second representation includes the step of describing the behavior of the electrical elements situated in each segment by lumped parameters.

35. The program product according to claim 34, wherein the method step of converting a first representation of said multiple layered power distribution system into a second representation includes the step of neglecting the wiring capacitance of said multiple layered power distribution system.

36. The program product according to claim 27, wherein the method step of analyzing the dynamic behavior of said electrical circuit based on said second representation of said multiple layered power distribution system is performed by means of a circuit simulator tool.

37. The program product according to claim 27, wherein the method further comprises the step of displaying the calculated voltage level variation (DU) in relation to a respective segment of said multiple layered power distribution system.

38. The program product according to claim 37, wherein the method step of displaying the calculated voltage level variation (DU) includes the step of creating a three-dimensional illustration representing the circuit area indicating the calculated voltage level variation (DU) in accordance with the values determined for each segment.

39. The program product according to claim 38, wherein the method step of creating a three-dimensional illustration includes the step of dividing the three-dimensional illustration in the same way as the circuit area.
